(19) United States
(12) Patent Application Publication
(10) Pub. No.: US 2024/0388931 A1
(43) Pub. Date: Nov. 21, 2024

(54) FAILURE DETECTION AND RECOVERY IN WIRELESS COMMUNICATIONS

(71) Applicant: LG ELECTRONICS INC., Seoul (KR)

(72) Inventors: Hongsuk KIM, Seoul (KR); Sunghoon JUNG, Seoul (KR)

(73) Assignee: LG ELECTRONICS INC., Seoul (KR)

(21) Appl. No.: 18/693,917

(22) PCT Filed: Oct. 19, 2022
(86) PCT No.: PCT/KR2022/015962

§ 371 Date: Mar. 20, 2024

Related U.S. Application Data
(60) Provisional application No. 63/270,542, filed on Oct. 21, 2021.

(51) Int. Cl. H04W 24/04; H04L 41/0686

(52) U.S. Cl. CPC H04W 24/04; H04L 41/0686

(57) ABSTRACT

The present disclosure relates to failure detection and recovery in wireless communications. According to an embodiment of the present disclosure, a user equipment (UE) may initiate a transmission of failure information for a cell group upon detecting a failure on the cell group, and determine whether to suspend a transmission on the cell group based on a cause of initiating the transmission of the failure information.

### CROSS-REFERENCE TO RELATED APPLICATION(S)

This application is the National Stage filing under 35 U.S.C. 371 of International Application No. PCT/KR2022/015962, filed on Oct. 19, 2022, which claims the benefit of U.S. Patent Application No. 63/270,542 filed on Oct. 21, 2021, the contents of which are all incorporated by reference herein in their entirety.

### TECHNICAL FIELD

The present disclosure relates to failure detection and recovery in wireless communications.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

In a wireless communication system, a user equipment (UE) may detect a failure on a cell group, such as master cell group (MCG) and/or secondary cell group (SCG). For example, if/when the UE detects a failure on the SCG, the UE may initiate a SCG failure information procedure to recover the failure on the SCG.

### SUMMARY

An aspect of the present disclosure is to provide method and apparatus for failure detection and recovery in a wireless communication system.

Another aspect of the present disclosure is to provide method and apparatus for detecting and recovering an SCG failure in a wireless communication system.

Another aspect of the present disclosure is to provide method and apparatus for an SCG failure information procedure in a wireless communication system.

According to an embodiment of the present disclosure, a method performed by a user equipment (UE) in a wireless communication system comprises: entering a deactivated state for a cell group: initiating a transmission of failure information for the cell group while the cell group is in the deactivated state; and suspending a transmission on the cell group based on a cause of initiating the transmission of the failure information for the cell group. The transmission on the cell group is not suspended based on the cause being a first cause that a beam failure for the cell group is detected while the cell group is in the deactivated state. The transmission on the cell group is suspended based on the cause being a second cause other than the first cause.

According to various embodiments, a method performed by a network node adapted to operate in a wireless communication system comprises: transmitting, to a user equipment (UE), a deactivation command to enter a deactivated state for a cell group: receiving, from the UE, failure information for the cell group while the cell group is in the deactivated state; and transmitting, to another network node related to the cell group, the failure information. Whether a transmission on the cell group is suspended is determined based on a cause of initiating the transmission of the failure information. The transmission on the cell group is not suspended based on the cause being a first cause that a beam failure for the cell group is detected while the cell group is in the deactivated state. The transmission on the cell group is suspended based on the cause being a second cause other than the first cause.

According to various embodiments, apparatuses implementing the above methods are provided.

The present disclosure can have various advantageous effects.

For example, the UE in SCG deactivation state can transmit the SCG failure information to the network even though SCG is suspended to transmission by additionally checking the cause of suspension to transmission on SCG. Therefore, the present disclosure support more time-efficient UE behavior because the UE can more properly indicate to the network that recovery is needed before SCG activation than legacy.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows another example of wireless devices to which implementations of the present disclosure is applied.

FIG. 5 shows an example of UE to which implementations of the present disclosure is applied.

FIGS. 6 and 7 show an example of protocol stacks in a 3GPP based wireless communication system to which implementations of the present disclosure is applied.

FIG. 8 shows a frame structure in a 3GPP based wireless communication system to which implementations of the present disclosure is applied.

FIG. 9 shows a data flow example in the 3GPP NR system to which implementations of the present disclosure is applied.

FIG. 10 shows an example of a dual connectivity (DC) architecture to which technical features of the present disclosure can be applied.

FIG. 11 shows an example of procedure for a transmission of SCG failure information according to an embodiment of the present disclosure.

FIG. 12 shows an example of a method performed by a UE according to an embodiment of the present disclosure.

FIG. 13 shows an example of a method performed by a network node according to an embodiment of the present disclosure.

FIG. 14 shows an example of a SCG failure information procedure according to an embodiment of the present disclosure.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE.

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Throughout the disclosure, the terms ‘radio access network (RAN) node’, ‘base station’, ‘eNB’, ‘gNB’ and ‘cell’ may be used interchangeably. Further, a UE may be a kind of a wireless device, and throughout the disclosure, the terms ‘UE’ and ‘wireless device’ may be used interchangeably.

Throughout the disclosure, the terms ‘cell quality’, ‘signal strength’, ‘signal quality’, ‘channel state’, ‘channel quality’, ‘channel state/reference signal received power (RSRP)’ and ‘reference signal received quality (RSRQ)’ may be used interchangeably.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

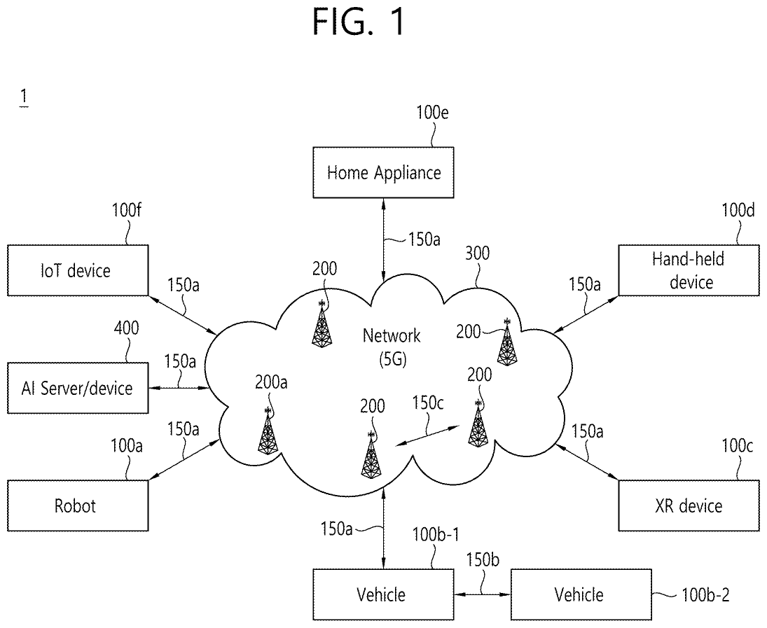

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IoT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

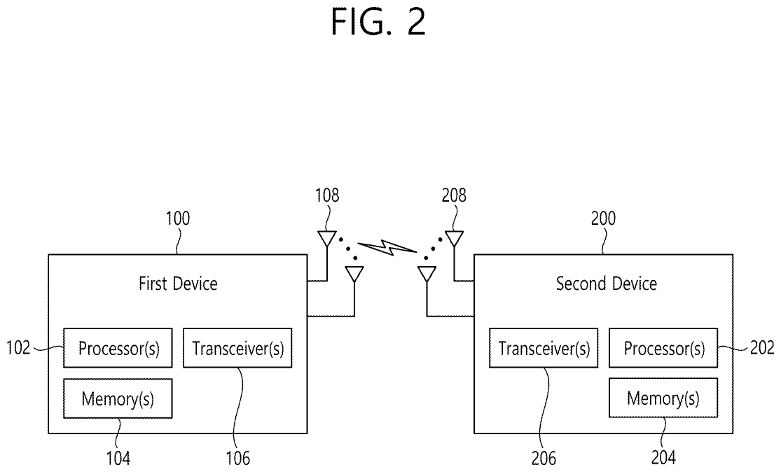

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR). In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to/adapted to implement the descriptions, functions, procedures, suggestions, methods and/or operational flowcharts described in the present disclosure. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, suggestions, methods and/or operational flowcharts described in the present disclosure. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with radio frequency (RF) unit(s). In the present disclosure, the first wireless device 100 may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to/adapted to implement the descriptions, functions, procedures, suggestions, methods and/or operational flowcharts described in the present disclosure. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, suggestions, methods and/or operational flowcharts described in the present disclosure. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. descriptions, functions, procedures, suggestions, methods and/or operational flowcharts disclosed in the present disclosure may be implemented using firmware or software and the firmware or software may be configured to/adapted to include the modules, procedures, or functions. Firmware or software configured to/adapted to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to/adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas may be a plurality of physical antennas or a plurality of logical antennas (e.g., antenna ports).

The one or more transceivers 106 and 206 may convert received radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the transceivers 106 and 206 can up-convert OFDM baseband signals to a carrier frequency by their (analog) oscillators and/or filters under the control of the processors 102 and 202 and transmit the up-converted OFDM signals at the carrier frequency. The transceivers 106 and 206 may receive OFDM signals at a carrier frequency and down-convert the OFDM signals into OFDM baseband signals by their (analog) oscillators and/or filters under the control of the transceivers 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to/adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to/adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

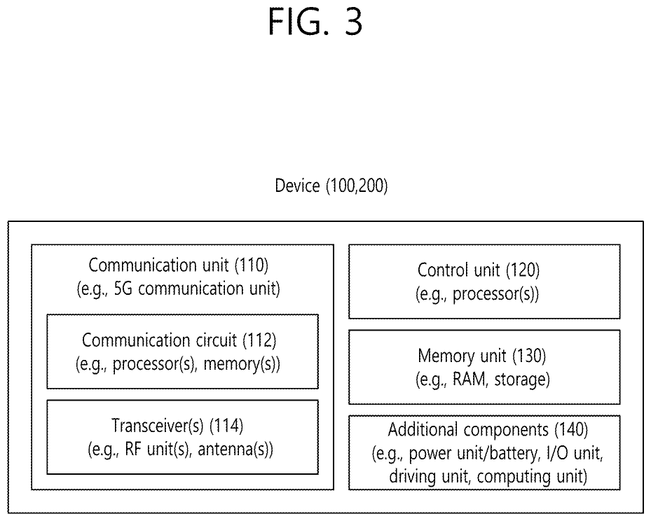

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory 130 may be configured by a RAM, a DRAM, a ROM, a flash memory, a volatile memory, a non-volatile memory, and/or a combination thereof.

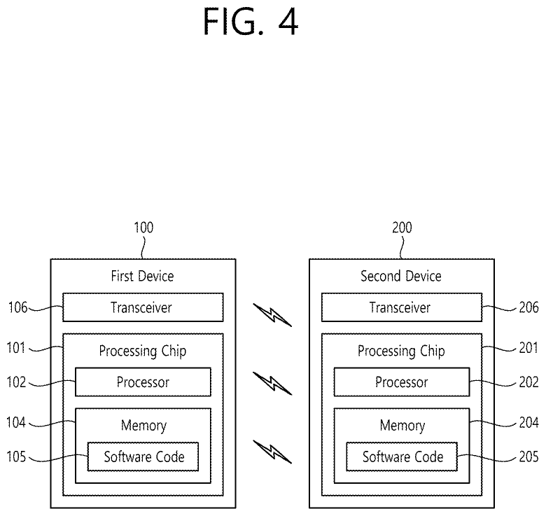

FIG. 4 shows another example of wireless devices to which implementations of the present disclosure is applied.

Referring to FIG. 4, wireless devices 100 and 200 may correspond to the wireless devices 100 and 200 of FIG. 2 and may be configured by various elements, components, units/portions, and/or modules.

The first wireless device 100 may include at least one transceiver, such as a transceiver 106, and at least one processing chip, such as a processing chip 101. The processing chip 101 may include at least one processor, such a processor 102, and at least one memory, such as a memory 104. The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 may perform one or more layers of the radio interface protocol.

The second wireless device 200 may include at least one transceiver, such as a transceiver 206, and at least one processing chip, such as a processing chip 201. The processing chip 201 may include at least one processor, such a processor 202, and at least one memory, such as a memory 204. The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 may perform one or more layers of the radio interface protocol.

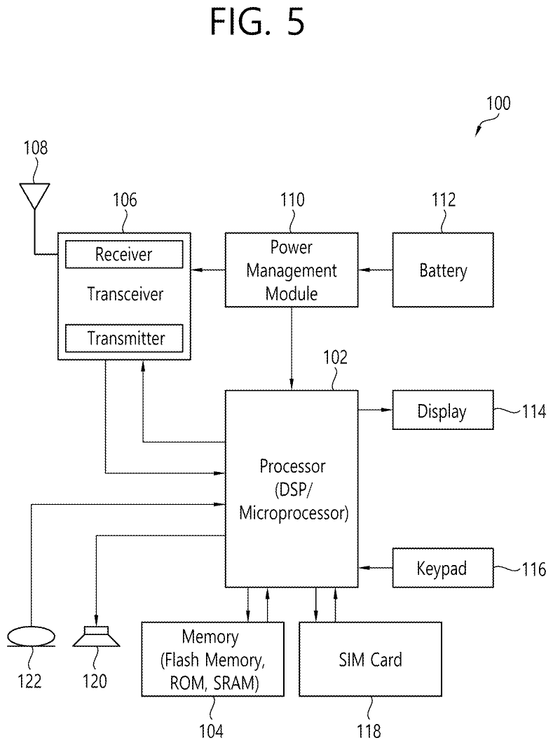

FIG. 5 shows an example of UE to which implementations of the present disclosure is applied.

Referring to FIG. 5, a UE 100 may correspond to the first wireless device 100 of FIG. 2 and/or the first wireless device 100 of FIG. 4.

A UE 100 includes a processor 102, a memory 104, a transceiver 106, one or more antennas 108, a power management module 110, a battery 1112, a display 114, a keypad 116, a subscriber identification module (SIM) card 118, a speaker 120, and a microphone 122.

The processor 102 may be configured to/adapted to implement the descriptions, functions, procedures, suggestions, methods and/or operational flowcharts disclosed in the present disclosure. The processor 102 may be configured to/adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of a digital signal processor (DSP), a central processing unit (CPU), a graphics processing unit (GPU), a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 16 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

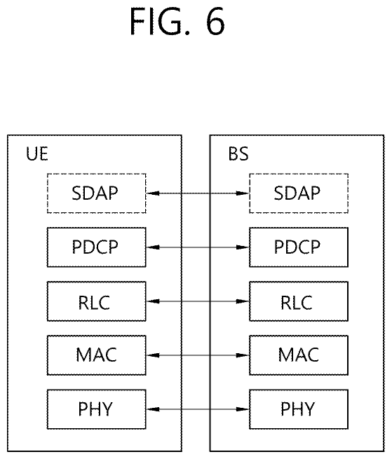

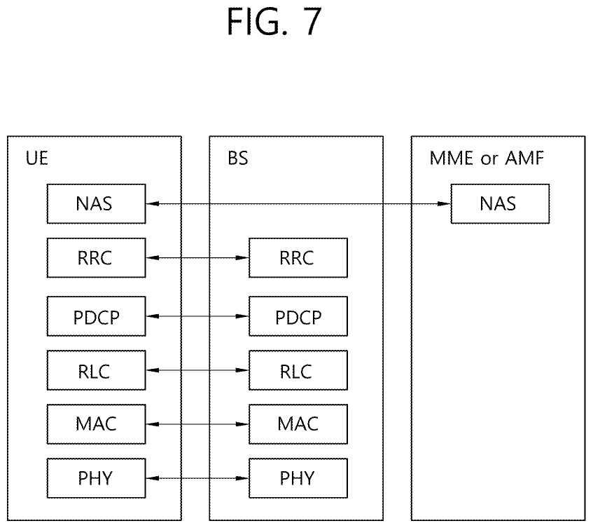

FIGS. 6 and 7 show an example of protocol stacks in a 3GPP based wireless communication system to which implementations of the present disclosure is applied.

In particular, FIG. 6 illustrates an example of a radio interface user plane protocol stack between a UE and a BS and FIG. 7 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 6, the user plane protocol stack may be divided into Layer 1 (i.e., a PHY layer) and Layer 2. Referring to FIG. 7, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QOS) flows.

In the 3GPP NR system, the main services and functions of the MAC sublayer include: mapping between logical channels and transport channels: multiplexing/de-multiplexing of MAC SDUs belonging to one or different logical channels into/from transport blocks (TB) delivered to/from the physical layer on transport channels: scheduling information reporting; error correction through hybrid automatic repeat request (HARQ) (one HARQ entity per cell in case of carrier aggregation (CA)): priority handling between UEs by means of dynamic scheduling: priority handling between logical channels of one UE by means of logical channel prioritization: padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH): DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS: paging initiated by 5GC or NG-RAN; establishment, maintenance and release of an RRC connection between the UE and NG-RAN; security functions including key management: establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

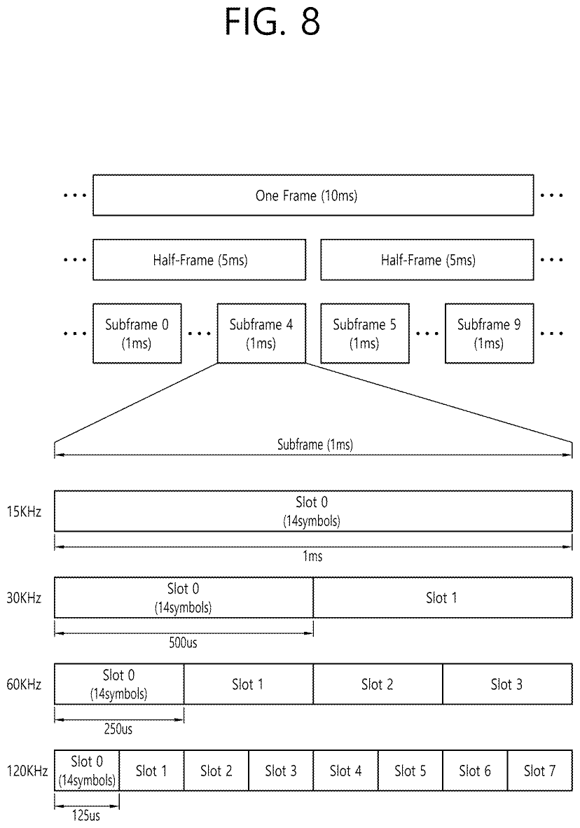

FIG. 8 shows a frame structure in a 3GPP based wireless communication system to which implementations of the present disclosure is applied.

The frame structure shown in FIG. 8 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 8, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing βf=2^{u}*15 KHz.

Table 1 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing βf=2^{u}*15 KHz.

TABLE 1

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 2 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing βf=2^{u}*15 KHz.

TABLE 2

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index/representing a symbol location relative to a reference point in the time domain. In the 3GPP based wireless communication system, an RB is defined by 12 consecutive subcarriers in the frequency domain. In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

The NR frequency band may be defined as two types of frequency range, i.e., FR1 and FR2. The numerical value of the frequency range may be changed. For example, the frequency ranges of the two types (FR1 and FR2) may be as shown in Table 3 below. For ease of explanation, in the frequency ranges used in the NR system, FR1 may mean “sub 6 GHz range”, FR2 may mean “above 6 GHz range,” and may be referred to as millimeter wave (mmW).

TABLE 3

| Frequency Range | Corresponding | |
|---|---|---|
| designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 4 below. That is, FR1 may include a frequency band of 6 GHZ (or 5850, 5900, 5925 MHz, etc.) or more. For example, a frequency band of 6 GHz (or 5850, 5900, 5925 MHZ, etc.) or more included in FR1 may include an unlicensed band. Unlicensed bands may be used for a variety of purposes, for example for communication for vehicles (e.g., autonomous driving).

TABLE 4

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times. In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

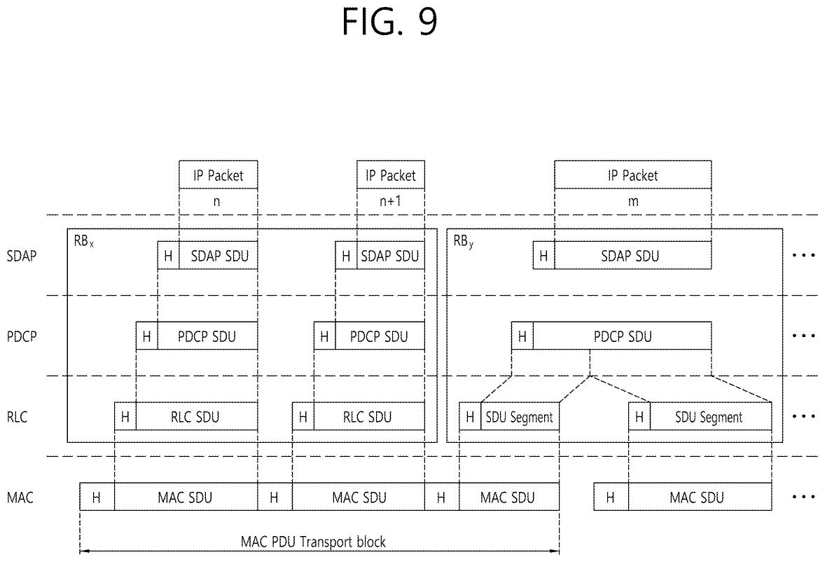

FIG. 9 shows a data flow example in the 3GPP NR system to which implementations of the present disclosure is applied.

Referring to FIG. 9, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels physical uplink shared channel (PUSCH) and physical random access channel (PRACH), respectively, and the downlink transport channels DL-SCH, BCH and PCH are mapped to physical downlink shared channel (PDSCH), physical broadcast channel (PBCH) and PDSCH, respectively. In the PHY layer, uplink control information (UCI) is mapped to physical uplink control channel (PUCCH), and downlink control information (DCI) is mapped to physical downlink control channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

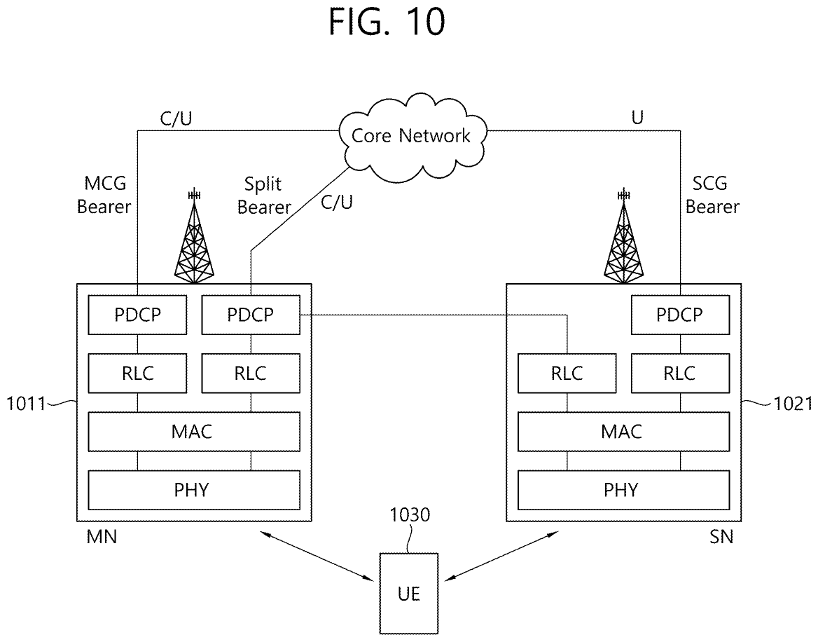

FIG. 10 shows an example of a dual connectivity (DC) architecture to which technical features of the present disclosure can be applied.

Referring to FIG. 10, MN 1011, SN 1021, and a UE 1030 communicating with both the MN 1011 and the SN 1021 are illustrated. As illustrated in FIG. 10, DC refers to a scheme in which a UE (e.g., UE 1030) utilizes radio resources provided by at least two RAN nodes comprising a MN (e.g., MN 1011) and one or more SNs (e.g., SN 1021). In other words, DC refers to a scheme in which a UE is connected to both the MN and the one or more SNs, and communicates with both the MN and the one or more SNs. Since the MN and the SN may be in different sites, a backhaul between the MN and the SN may be construed as non-ideal backhaul (e.g., relatively large delay between nodes).

MN (e.g., MN 1011) refers to a main RAN node providing services to a UE in DC situation. SN (e.g., SN 1021) refers to an additional RAN node providing services to the UE with the MN in the DC situation. If one RAN node provides services to a UE, the RAN node may be a MN. SN can exist if MN exists.

For example, the MN may be associated with macro cell whose coverage is relatively larger than that of a small cell. However, the MN does not have to be associated with macro cell—that is, the MN may be associated with a small cell. Throughout the disclosure, a RAN node that is associated with a macro cell may be referred to as ‘macro cell node’. MN may comprise macro cell node.

For example, the SN may be associated with small cell (e.g., micro cell, pico cell, femto cell) whose coverage is relatively smaller than that of a macro cell. However, the SN does not have to be associated with small cell—that is, the SN may be associated with a macro cell. Throughout the disclosure, a RAN node that is associated with a small cell may be referred to as ‘small cell node’. SN may comprise small cell node.

The MN may be associated with a master cell group (MCG). MCG may refer to a group of serving cells associated with the MN, and may comprise a primary cell (PCell) and optionally one or more secondary cells (SCells). User plane data and/or control plane data may be transported from a core network to the MN through a MCG bearer. MCG bearer refers to a bearer whose radio protocols are located in the MN to use MN resources. As shown in FIG. 10, the radio protocols of the MCG bearer may comprise PDCP, RLC, MAC and/or PHY.

The SN may be associated with a secondary cell group (SCG). SCG may refer to a group of serving cells associated with the SN, and may comprise a primary secondary cell (PSCell) and optionally one or more SCells. User plane data may be transported from a core network to the SN through a SCG bearer. SCG bearer refers to a bearer whose radio protocols are located in the SN to use SN resources. As shown in FIG. 10, the radio protocols of the SCG bearer may comprise PDCP, RLC, MAC and PHY.

User plane data and/or control plane data may be transported from a core network to the MN and split up/duplicated in the MN, and at least part of the split/duplicated data may be forwarded to the SN through a split bearer. Split bearer refers to a bearer whose radio protocols are located in both the MN and the SN to use both MN resources and SN resources. As shown in FIG. 10, the radio protocols of the split bearer located in the MN may comprise PDCP, RLC, MAC and PHY. The radio protocols of the split bearer located in the SN may comprise RLC, MAC and PHY.

According to various embodiments, PDCP anchor/PDCP anchor point/PDCP anchor node refers to a RAN node comprising a PDCP entity which splits up and/or duplicates data and forwards at least part of the split/duplicated data over X2/Xn interface to another RAN node. In the example of FIG. 10, PDCP anchor node may be MN.

According to various embodiments, the MN for the UE may be changed. This may be referred to as handover, or a MN handover.

According to various embodiments, a SN may newly start providing radio resources to the UE, establishing a connection with the UE, and/or communicating with the UE (i.e., SN for the UE may be newly added). This may be referred to as a SN addition.

According to various embodiments, a SN for the UE may be changed while the MN for the UE is maintained. This may be referred to as a SN change.

According to various embodiments, DC may comprise E-UTRAN NR-DC (EN-DC), and/or multi-radio access technology (RAT)-DC (MR-DC). EN-DC refers to a DC situation in which a UE utilizes radio resources provided by E-UTRAN node and NR RAN node. MR-DC refers to a DC situation in which a UE utilizes radio resources provided by RAN nodes with different RATs.

Hereinafter, radio link failure (RLF) related actions are described.

UE may detect physical layer problems in RRC_CONNECTED. To detect the physical layer problems, the UE shall:
1> if any DAPS bearer is configured, upon receiving N310 consecutive “out-of-sync” indications for the source SpCell from lower layers and T304 is running:
2> start timer T310 for the source SpCell.

1> upon receiving N310 consecutive “out-of-sync” indications for the SpCell from lower layers while neither T300, T301, T304, T311, T316 nor T319 are running:

2> start timer T310 for the corresponding SpCell.

The UE may recover the physical layer problems upon receiving N311 consecutive “in-sync” indications for the SpCell from lower layers while T310 is running. Upon receiving N311 consecutive “in-sync” indications for the SpCell from lower layers while T310 is running, the UE shall:
1> stop timer T310 for the corresponding SpCell.
1> stop timer T312 for the corresponding SpCell, if running.

In this case, the UE maintains the RRC connection without explicit signalling, i.e. the UE maintains the entire radio resource configuration.

Periods in time where neither “in-sync” nor “out-of-sync” is reported by L1 do not affect the evaluation of the number of consecutive “in-sync” or “out-of-sync” indications.

To detect the radio link failure, the UE shall:
1> if any DAPS bearer is configured and T304 is running:
2> upon T310 expiry in source SpCell; or
2> upon random access problem indication from source MCG MAC; or
2> upon indication from source MCG RLC that the maximum number of retransmissions has been reached: or
2> upon consistent uplink LBT failure indication from source MCG MAC:
3> consider radio link failure to be detected for the source MCG i.e. source RLF;
3> suspend the transmission and reception of all DRBs in the source MCG;
3> reset MAC for the source MCG;
3> release the source connection.

1> else:
2> during a DAPS handover: the following only applies for the target PCell;
2> upon T310 expiry in PCell; or
2> upon T312 expiry in PCell; or
2> upon random access problem indication from MCG MAC while neither T300, T301, T304, T311 nor T319 are running; or
2> upon indication from MCG RLC that the maximum number of retransmissions has been reached; or
2> if connected as an IAB-node, upon BH RLF indication received on BAP entity from the MCG; or
2> upon consistent uplink LBT failure indication from MCG MAC while T304 is not running:
3> if the indication is from MCG RLC and CA duplication is configured and activated for MCG, and for the corresponding logical channel allowedServingCells only includes SCell(s):
4> initiate the failure information procedure to report RLC failure.

3> else:
4> consider radio link failure to be detected for the MCG, i.e. MCG RLF;
4> discard any segments of segmented RRC messages;
4> if AS security has not been activated;
5> perform the actions upon going to RRC_IDLE, with release cause ‘other’;
4> else if AS security has been activated but SRB2 and at least one DRB or, for IAB, SRB2, have not been setup:
5> store the radio link failure information in the VarRLF-Report;
5> perform the actions upon going to RRC_IDLE, with release cause ‘RRC connection failure’;
4> else:
5> store the radio link failure information in the VarRLF-Report;
5> if T316 is configured; and
5> if SCG transmission is not suspended; and
5> if neither PSCell change nor PSCell addition is ongoing (i.e. timer T304 for the NR PSCell is not running in case of NR-DC or timer T307 of the E-UTRA PSCell is not running, in NE-DC):
6> initiate the MCG failure information procedure to report MCG radio link failure.
5> else:
6> initiate the connection re-establishment procedure.

The UE shall:
1> upon T310 expiry in PSCell; or
1> upon T312 expiry in PSCell; or
1> upon random access problem indication from SCG MAC; or
1> upon indication from SCG RLC that the maximum number of retransmissions has been reached; or
1> if connected as an IAB-node, upon BH RLF indication received on BAP entity from the SCG; or
1> upon consistent uplink LBT failure indication from SCG MAC:
2> if the indication is from SCG RLC and CA duplication is configured and activated for SCG, and for the corresponding logical channel allowedServingCells only includes SCell(s):
3> initiate the failure information procedure to report RLC failure.

2> else:
3> consider radio link failure to be detected for the SCG, i.e. SCG RLF;
3> if MCG transmission is not suspended:
4> initiate the SCG failure information procedure to report SCG radio link failure.

3> else:
4> if the UE is in NR-DC:
5> initiate the connection re-establishment procedure;
4> else (the UE is in (NG) EN-DC):
5> initiate the connection re-establishment procedure.

Hereinafter, beam failure related actions are described.

The MAC entity may be configured by RRC per Serving Cell with a beam failure recovery procedure which is used for indicating to the serving gNB of a new SSB or CSI-RS when beam failure is detected on the serving SSB(s)/CSI-RS(s). Beam failure is detected by counting beam failure instance indication from the lower layers to the MAC entity. If beamFailureRecoveryConfig is reconfigured by upper layers during an ongoing Random Access procedure for beam failure recovery for SpCell, the MAC entity shall stop the ongoing Random Access procedure and initiate a Random Access procedure using the new configuration.

RRC configures the BeamFailureRecoveryConfig, BeamFailureRecoverySCellConfig, and the RadioLinkMonitoringConfig for the Beam Failure Detection and Recovery procedure.
BFI_COUNTER (per Serving Cell): counter for beam failure instance indication which is initially set to 0.

The MAC entity shall for each Serving Cell configured for beam failure detection:
1> if beam failure instance indication has been received from lower layers:
2> start or restart the beamFailureDetectionTimer;
2> increment BFI_COUNTER by 1;
2> if BFI_COUNTER>=beamFailureInstanceMaxCount:
3> if the Serving Cell is SCell:
4> trigger a BFR for this Serving Cell;
3> else:
4> initiate a Random Access procedure on the SpCell.

1> if the beamFailureDetectionTimer expires; or
1> if beamFailureDetectionTimer, beamFailureInstanceMaxCount, or any of the reference signals used for beam failure detection is reconfigured by upper layers associated with this Serving Cell:
2> set BFI_COUNTER to 0.

1> if the Serving Cell is SpCell and the Random Access procedure initiated for SpCell beam failure recovery is successfully completed:
2> set BFI_COUNTER to 0;
2> stop the beamFailureRecoveryTimer, if configured;
2> consider the Beam Failure Recovery procedure successfully completed.

1> else if the Serving Cell is SCell, and a PDCCH addressed to C-RNTI indicating uplink grant for a new transmission is received for the HARQ process used for the transmission of the BFR MAC CE or Truncated BFR MAC CE which contains beam failure recovery information of this Serving Cell; or
1> if the SCell is deactivated:
2> set BFI_COUNTER to 0;
2> consider the Beam Failure Recovery procedure successfully completed and cancel all the triggered BFRs for this Serving Cell.

In the above, the UE variable BFI_COUNTER can be defined per Serving Cell, and is a counter for beam failure instance indication which is initially set to 0.

The MAC entity shall:
1> if the Beam Failure Recovery procedure determines that at least one BFR has been triggered and not cancelled for an SCell for which evaluation of the candidate beams has been completed:
2> if UL-SCH resources are available for a new transmission and if the UL-SCH resources can accommodate the BFR MAC CE plus its subheader as a result of LCP:
3> instruct the Multiplexing and Assembly procedure to generate the BFR MAC CE.

2> else if UL-SCH resources are available for a new transmission and if the UL-SCH resources can accommodate the Truncated BFR MAC CE plus its subheader as a result of LCP:
3> instruct the Multiplexing and Assembly procedure to generate the Truncated BFR MAC CE.

2> else:
3> trigger the SR for SCell beam failure recovery for each SCell for which BFR has been triggered, not cancelled, and for which evaluation of the candidate beams has been completed.

All BFRs triggered for an SCell shall be cancelled when a MAC PDU is transmitted and this PDU includes a BFR MAC CE or Truncated BFR MAC CE which contains beam failure information of that SCell.

Hereinafter, SCG failure information procedure is described.

The purpose of the SCG failure information procedure is to inform E-UTRAN or NR MN about an SCG failure the UE has experienced.

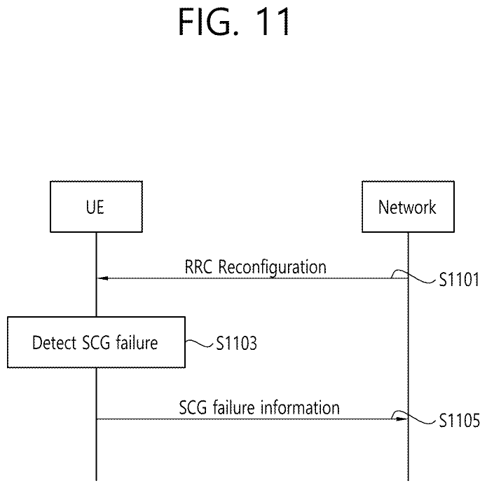

FIG. 11 shows an example of procedure for a transmission of SCG failure information according to an embodiment of the present disclosure.

Referring to FIG. 11, in step S1101, UE may receive RRC reconfiguration from a network.

In step S1103, the UE may detect a failure on SCG (i.e., SCG failure). The UE may detect the SCG failure based on the RRC reconfiguration.

In step S1105, the UE may transmit SCG failure information to MCG. The SCG failure information may be forwarded by the MCG to the SCG. The UE may initiate a transmission of the SCG failure information upon/after detecting the SCG failure.

According to various embodiments, the SCG failure may comprise at least one of SCG radio link failure, failure of SCG reconfiguration with sync, SCG configuration failure for RRC message on SRB3, SCG integrity check failure or consistent uplink LBT failures on PSCell for operation with shared spectrum channel access.

In some implementations, a UE may consider a BWP as being in a deactivated state/dormant state for power saving. For example, the UE may consider the BWP as being in the deactivated/dormant state if the UE receives a command via MAC CE or DCI from a network. For another example, the UE may consider the BWP as being in the deactivated/dormant state if a pre-determined condition is met (e.g., there is no traffic activity on UL and/or DL on the BWP for a pre-determined period). The UE may consider the BWP as being in an activated state if the UE receives a command via MAC CE or DCI from a network, a deactivation/dormant period on the BWP expires or a random access (RA) is triggered on the BWP during the deactivated/dormant state.

The activated state may refer to a state in which the UE monitors a first set of resources for a control channel on the cell group/BWP. For example, in the activated state, the UE monitors downlink control channel (PDCCH) for downlink scheduling, performs CSI measurements, performs CSI reporting, if needed, and/or has opportunities to request uplink scheduling, if needed.

The deactivated state may refer to a state in which the UE monitors a second set of resources for a control channel on the cell group/BWP, or does not monitor a control channel on the cell group/BWP. For example, in the deactivated state, the UE does not monitor downlink control channel (PDCCH) for downlink scheduling, does not perform CSI measurements and/or does not perform CSI reporting.

The first/second set of resources for a control channel may comprise a control resource set (CORESET) and/or one or more PDCCHs. The second set of resources may comprise sparser resources than the first set of resources.

The dormant state may refer to a state in which the UE does not monitor downlink control channel (PDCCH) for downlink scheduling, but perform CSI measurements. The UE may not be required to perform CSI reporting in a dormant state to save power consumption. Dormant state may be classified as a sub-state of the activated state.

For a UE configured with MCG and SCG, the UE may deactivate SCG (i.e., consider the SCG as being in a deactivated/dormant state) for power saving. While the SCG is deactivated, the UE may need to keep radio link monitoring to check if the SCG is usable. If a failure (e.g., SCG failure/beam failure) is detected, the UE may need to report the failure to network via MCG or to perform recovery procedure. Since the radio link monitoring requires a consistent UE power consumption, more power-efficient radio link monitoring is beneficial for deactivated SCG. Since link failure report may require extra UE power consumption for uplink transmission, relaxation of link failure criteria for deactivated SCG may be beneficial for power saving.

Upon reception of the RRCReconfiguration, the UE shall:
1> if the UE is configured with E-UTRA nr-SecondaryCellGroupConfig (UE in (NG) EN-DC):
2> if the RRCReconfiguration message was received via E-UTRA SRB1; or
2> if the RRCReconfiguration message was received via E-UTRA RRC message RRCConnectionReconfiguration within MobilityFromNRCommand (handover from NR standalone to (NG)EN-DC);
3> if the scg-State is not included in the E-UTRA RRCConnectionReconfiguration message or E-UTRA RRCConnectionResume message containing the RRCReconfiguration message:
4> perform SCG activation;
4> if reconfigurationWithSync was included in spCellConfig of an SCG:
5> initiate the Random Access procedure on the PSCell;
4> else if the SCG was deactivated before the reception of the E-UTRA RRC message containing the RRCReconfiguration message:
5> if bfd-and-RLM was not configured to true before the reception of the E-UTRA RRCConnectionReconfiguration or RRCConnectionResume message containing the RRCReconfiguration message or if lower layers indicate that a Random Access procedure is needed for SCG activation:
6> initiate the Random Access procedure on the SpCell;
3> else:
4> perform SCG deactivation.

1> else if the RRCReconfiguration message was received via SRB1 within the nr-SCG within mrdc-SecondaryCellGroup (UE in NR-DC, mrdc-SecondaryCellGroup was received in RRCReconfiguration or RRCResume via SRB1):
2> if the RRCReconfiguration is applied due to a conditional reconfiguration execution for CPC which is configured via conditionalReconfiguration contained in nr-SCG within mrdc-SecondaryCellGroup:
3> submit the RRCReconfigurationComplete message via the NR MCG embedded in NR RRC message ULInformationTransferMRDC.

2> if the seg-State is not included in the RRCReconfiguration or RRCResume message containing the RRCReconfiguration message:
3> if the SCG was deactivated before the reception of the NR RRC message containing the RRCReconfiguration message:
4> perform SCG activation;
3> if reconfigurationWithSync was included in spCellConfig in nr-SCG:
4> initiate the Random Access procedure on the PSCell;
3> else if the SCG was deactivated before the reception of the NR RRC message containing the RRCReconfiguration message:
4> if bfd-and-RLM was not configured to true before the reception of the RRCReconfiguration or RRCResume message containing the RRCReconfiguration message; or
4> if lower layers indicate that a Random Access procedure is needed for SCG activation:
5> initiate the Random Access procedure on the PSCell;
2> else
3> perform SCG deactivation.

1> if RRCReconfiguration was received via SRB1:
2> if the UE is in NR-DC and;
2> if the RRCReconfiguration does not include the mrdc-SecondaryCellGroupConfig:
3> if the RRCReconfiguration includes the scg-State:
4> perform SCG deactivation;
3> else:
4> perform SCG activation without SN message.

Upon reception of the RRCResume, the UE shall:
1> if the RRCResume includes the mrdc-SecondaryCellGroup:
2> if the received mrdc-SecondaryCellGroup is set to nr-SCG:
3> if the RRCResume includes the scg-State:
4> perform SCG deactivation;
3> else:
4> perform SCG activation.

Upon initiating the SCG activation and/or while performing the SCG activation, the UE shall:
1> if the UE is configured with an SCG after receiving the message for which this procedure is initiated:
2> if the UE was configured with a deactivated SCG before receiving the message for which this procedure is initiated:
3> consider the SCG to be activated;
3> resume performing radio link monitoring on the SCG, if previously stopped;
3> indicate to lower layers to resume beam failure detection on the PSCell, if previously stopped;
3> indicate to lower layers that the SCG is activated.

Upon initiating the SCG deactivation and/or while performing the SCG deactivation, the UE shall:
1> consider the SCG to be deactivated;
1> indicate to lower layers that the SCG is deactivated;
1> if bfd-and-RLM is configured to true:
2> perform radio link monitoring on the SCG;
2> indicate to lower layers to perform beam failure detection on the PSCell;
1> else:
2> stop radio link monitoring on the SCG;
2> indicate to lower layers to stop beam failure detection on the PSCell;
2> stop timer T310 for this cell group, if running;
2> stop timer T312 for this cell group, if running;
2> reset the counters N310 and N311;
1> if the UE was in RRC_CONNECTED and the SCG was activated before receiving the message for which this procedure is initiated:
2> if SRB3 was configured before the reception of the RRCReconfiguration or of the RRCConnectionReconfiguration and SRB3 is not to be released according to any RadioBearerConfig included in the RRCReconfiguration or in the RRCConnectionReconfiguration:
3> trigger the PDCP entity of SRB3 to perform SDU discard;
3> re-establish the RLC entity of SRB3.

Upon initiating the SCG activation without SN message and/or while performing the SCG activation without SN message, the UE shall:
1> if the SCG was deactivated before the reception of the RRCReconfiguration message or the E-UTRA RRCConnectionReconfiguration message for which this procedure is executed:
2> consider the SCG to be activated;
2> indicate to lower layers that the SCG is activated;
2> if bfd-and-RLM was not configured to true before the reception of the RRCReconfiguration message or the E-UTRA RRCConnectionReconfiguration message for which the procedure invoking this clause is executed; or
2> if lower layers indicate that a Random Access procedure is needed for SCG activation:
3> initiate the Random Access procedure on the PSCell.

For the configured SCG, the MAC entity shall:
1> if upper layers indicate that SCG is activated:
2> if BFI_COUNTER>=beamFailureInstanceMaxCount for the PSCell or the timeAlignmentTimer associated with PTAG is not running:
3> indicate to upper layers that a Random Access Procedure) is needed for SCG activation.

2> else:
3> activate the SCG according to the timing for direct SCG activation.

2> (re-) initialize any suspended configured uplink grants of configured grant Type 1 associated with this PSCell according to the stored configuration, if any, and to start in the symbol;
2> apply normal SCG operation including:
3> SRS transmissions on the PSCell;
3> CSI reporting for the PSCell;
3> PDCCH monitoring on the PSCell;
3> PUCCH transmissions on the PSCell;
3> transmit on RACH on the PSCell;
3> initialize Bj for each logical channel to zero.

1> else if upper layers indicate that the SCG is deactivated:
2> deactivate all the SCells of the SCG;
2> deactivate SCG according to the timing;
2> clear any configured downlink assignment and any configured uplink grant Type 2 associated with the PSCell respectively;
2> suspend any configured uplink grant Type 1 associated with the PSCell;
2> reset MAC.

1> if the SCG is deactivated:
2> not transmit SRS on the PSCell;
2> not report CSI for the PSCell;
2> not transmit on UL-SCH on the PSCell;
2> not transmit PUCCH on the PSCell;
2> not transmit on RACH on the PSCell;
2> not monitor the PDCCH on the PSCell.

Meanwhile, PSCell can be suspended for SCG deactivation. Through SCG deactivation, the UE can simply reuse the previously applied SCG configuration and the SCG deactivation enables not only time-efficient SCG operation by reducing activation time but also power-efficient SCG operation by not monitoring PDCCH and by not transmitting PDSCH and PUSCH transmission on PSCell. That is, while SCG is deactivated, the UE may maintain SCG configuration but doesn't perform DL and UL data transmission on SCG. Thus, the UE may suspend a transmission to SCG while SCG is deactivated.

In addition, the UE in SCG-deactivated state may transmit SCG failure information to the network (e.g., MCG) for power saving which maintains SCG as deactivated instead of initiating a random access procedure for beam failure recovery when a beam failure is detected on PSCell.

In some situations, there may be a need to check why SCG is suspended for transmission on SCG based on condition(s). Thus, if SCG transmission is suspended due to reception of the SCG deactivation command, the UE may not be able to transmit SCG failure information while the SCG is deactivated.

In addition, if the UE transmits SCG failure information due to the beam failure without performing beam failure recovery, SCG failure information to inform the network of the PSCell link problem (e.g., RLF on SCG) cannot be transmitted when secondary radio link failure (S-RLF) (i.e., RLF on SCG) can be detected later.

In the present disclosure, when SCG failure is detected while SCG is deactivated, if the SCG is suspended for transmission, the UE may check the cause of the suspension for transmission. That is, the UE may check whether the suspension is due to the SCG failure, e.g., sending the SCG failure information via the MCG. If the cause of the suspension is not due to the SCG failure, the UE may initiate to report SCG failure information to the network even in the suspension for transmission on SCG. When reporting the SCG failure information to the network, the UE may change the cause of the suspension for transmission to the SCG failure.

After sending the SCG failure information to the network, the UE doesn't initiate to report SCG failure information before reception of RRC signalling from the network for SCG recovery because the cause of the suspension for transmission is the SCG failure.

The SCG failure can occur by at least one of the following conditions:
upon detecting radio link failure on SCG; and/or
upon execution failure of the PSCell change command for SCG; and/or
upon SCG configuration failure; and/or
upon integrity check failure indication from SCG lower layers concerning SRB3.

For the case of detection of a beam failure for SCG while SCG is deactivated, the UE may also initiate to report SCG failure information to the network even in the suspension for transmission on SCG. However, the UE doesn't change the cause of the suspension for transmission to SCG failure because the detection of beam failure isn't cell level problem. That is, the UE doesn't set the cause of the suspension for transmission to SCG failure if the SCG failure information is initiated by the beam failure. Thus, after sending the SCG failure information due to the detection of the beam failure, the UE may initiate to report SCG failure information again before reception of RRC signalling form the network for SCG recovery because the cause of the suspension for transmission isn't the SCG failure.

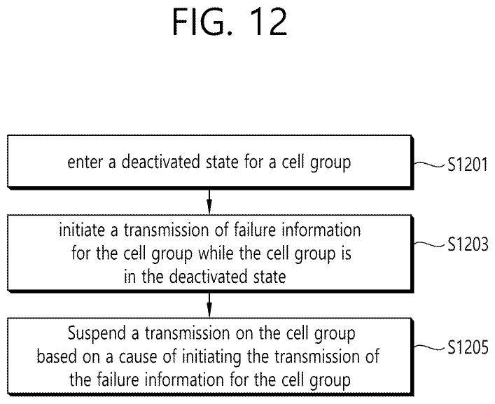

FIG. 12 shows an example of a method performed by a UE according to an embodiment of the present disclosure. The method may also be performed by a wireless device.

Referring to FIG. 12, in step S1201, the UE may enter a deactivated state for a cell group.

In step S1203, the UE may initiate a transmission of failure information for the cell group while the cell group is in the deactivated state.

In step S1205, the UE may suspend a transmission on the cell group based on a cause of initiating the transmission of the failure information for the cell group.

According to various embodiments, the UE does not suspend the transmission on the cell group based on the cause of the initiation being a first cause, and may suspend the transmission on the cell group based on the cause of the initiation being a second cause. In the present disclosure and various embodiments, the first cause is that a beam failure for the cell group is detected while the cell group is in the deactivated state, and the second cause is other initiation cause than the first cause.

According to various embodiments, the UE may suspend the transmission on the cell group based on not only the cause of the initiation being the second cause but also the cause of the initiation being the first cause. In this case, the UE may consider a cause of the suspension differently. For example, based on the cause of the initiation being the first cause, the UE may consider that the transmission on the cell group is not suspended due to the second cause, but suspended due to the first cause. For another example, based on the cause of the initiation being the second cause, the UE may consider that the transmission on the cell group is suspended due the second cause.

According to various embodiments, the cell group may comprise a secondary cell group (SCG) including a primary secondary cell (PSCell). The beam failure for the cell group may comprise a beam failure for the PSCell.

According to various embodiments, the second cause may comprise at least one of: a radio link failure (RLF) on the cell group; an execution failure of a mobility command for the cell group; a configuration failure of the cell group; an integrity check failure for the cell group; or consistent uplink listen-before-talk (LBT) failures on the cell group for operation with an unlicensed band.

According to various embodiments, the UE may detect the beam failure for the cell group while the cell group is in the deactivated state. The UE may initiate a transmission of first failure information for the cell group upon detecting the beam failure for the cell group while the cell group is in the deactivated state. The transmission on the cell group may not suspended based on initiating the transmission of the first failure information upon detecting the beam failure for the cell group while the cell group is in the deactivated state. The UE may transmit, to a network (e.g., MCG), the first failure information based on initiating the transmission of the first failure information.

According to various embodiments, the first failure information may inform that the beam failure is detected on the cell group.

According to various embodiments, after transmitting the first failure information, the UE may initiate a transmission of second failure information for the cell group while the transmission on the cell group is not suspended. The UE may transmit, to the network (e.g., MCG), the second failure information based on initiating the transmission of the second failure information.

According to various embodiments, the transmission of the second failure information may be initiated upon the UE detecting the second cause. The second failure information may inform that a failure related to the second cause is detected on the cell group.

According to various embodiments, the transmission of the second failure information may be initiated upon the UE detecting a beam failure for the cell group while the cell group is in the deactivated state. The second failure information may inform that a beam failure is detected on the cell group.

According to various embodiments, the UE may receive, from the network (e.g., MCG), a signalling for a recovery of the beam failure for the cell group after transmitting the first failure information. The transmission of the second failure information may be initiated before receiving the signalling for a recovery of the beam failure for the cell group.

According to various embodiments, the UE may initiate the transmission of the failure information upon detecting the second cause. The UE may transmit the failure information to a network (e.g, MCG) and suspend the transmission on the cell group based on initiating the transmission of the failure information upon detecting the second cause.

According to various embodiments, the UE may suspend the transmission on the cell group, based on the transmission of the failure information being not initiated upon the UE detecting the beam failure for the cell group while the cell group is in the deactivated state.

According to various embodiments, the deactivated state may comprise a state in which the UE does not monitor a control channel on the cell group or monitors sparser resources for a control channel on the cell group than in an activated state.

According to various embodiments, the UE may receive an indication from a network to deactivate a cell group and deactivate the cell group. The UE may detect a condition among plurality of conditions to send a cell group failure information to the network while the cell group is deactivated. The UE may check whether transmission is suspended on the cell group. The UE may check whether a cause of suspension when the transmission is suspended on the cell group. The UE may send the cell group failure information to the network when the cause of suspension is not by the condition to send the cell group failure information. The UE may receive an RRC signaling from the network to recover the cell group after sending the cell group failure information.

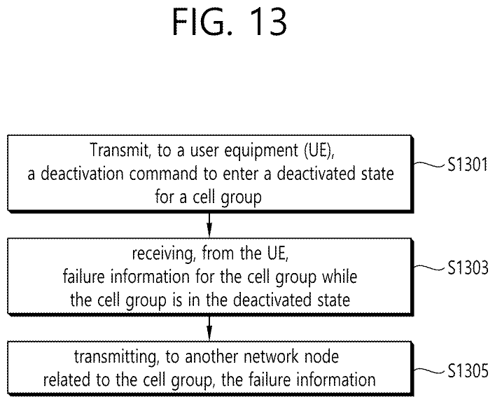

FIG. 13 shows an example of a method performed by a network node according to an embodiment of the present disclosure. The network node may comprise a base station (BS), and may be related to MCG.

Referring to FIG. 13, in step S1301, the network node may transmit, to a UE, a deactivation command to enter a deactivated state for a cell group.

In step S1303, the network node may receive, from the UE, failure information for the cell group while the cell group is in the deactivated state.

In step S1305, the UE may transmit, to another network node related to the cell group, the failure information.

In FIG. 13, whether a transmission on the cell group is suspended may be determined based on a cause of initiating the transmission of the failure information. For example, the transmission on the cell group may not be suspended based on the cause being a first cause that a beam failure for the cell group is detected while the cell group is in the deactivated state. For another example, the transmission on the cell group may be suspended based on the cause being a second cause other than the first cause.

According to an embodiment of the present disclosure, the UE shall perform the following actions upon reception of the RRCReconfiguration. or upon execution of the conditional reconfiguration (CHO or CPC):
1> if the RRCReconfiguration indicates that the UE consider the SCG to be deactivated:
2> suspend SCG transmission for all SRBs, DRBs and, if any.

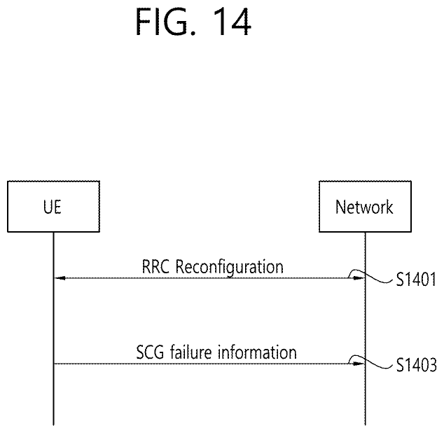

FIG. 14 shows an example of a SCG failure information procedure according to an embodiment of the present disclosure.

Referring to FIG. 14, in step S1401, the UE and network may perform an RRC reconfiguration. The UE may receive an RRC reconfiguration message from the network.

In step S1403, the UE may transmit a SCG failure information message to the network. The UE may perform the SCG failure information procedure based on the RRC reconfiguration.

The purpose of the SCG failure information procedure is to inform E-UTRAN or NR MN about an SCG failure the UE has experienced i.e. SCG radio link failure, failure of SCG reconfiguration with sync, SCG configuration failure for RRC message on SRB3, SCG integrity check failure, consistent uplink LBT failures on PSCell for operation with shared spectrum channel access, and/or beam failure while SCG is deactivated.

According to an embodiment of the present disclosure, UE may initiate the SCG failure information procedure to report SCG failures when SCG is not suspended or SCG transmission is suspended due to other procedures and when MCG is not suspended and when one of the following conditions is met:
1> upon detecting radio link failure for the SCG;
1> upon reconfiguration with sync failure of the SCG;
1> upon SCG configuration failure;
1> upon integrity check failure indication from SCG lower layers concerning SRB3; and/or
1> upon detecting the first beam failure for PSCell before beam failure recovery while SCG is deactivated.

Upon initiating the SCG failure information procedure, the UE shall:
1> suspend SCG transmission for all SRBs, DRBs and, if any, BH RLC channels if SCG is not suspended;
1> if SCG is deactivated and the procedure isn't initiated by detecting the beam failure for PSCell:
2> consider that SCG is suspended due to this procedure, i.e. SCG failure;
1> reset SCG MAC;
1> stop T304 for the SCG, if running;
1> stop conditional reconfiguration evaluation for CPC, if configured;
1> if the UE is in (NG) EN-DC:
2> initiate transmission of the SCGFailureInformationNR message.

1> else:
2> initiate transmission of the SCGFailureInformation message.

According to an embodiment of the present disclosure, UE may initiate the SCG failure information procedure to report SCG failures when neither MCG nor SCG transmission is suspended and when one of the following conditions is met:
1> upon detecting radio link failure for the SCG;
1> upon detecting beam failure of the PSCell while the SCG is deactivated;
1> upon reconfiguration with sync failure of the SCG;
1> upon SCG configuration failure; and/or
1> upon integrity check failure indication from SCG lower layers concerning SRB3.

Upon initiating the SCG failure information procedure, the UE shall:
1> if the procedure was not initiated due to beam failure of the PSCell while the SCG is deactivated:
2> suspend SCG transmission for all SRBs, DRBs and, if any, BH RLC channels;
2> reset SCG MAC;
1> stop T304 for the SCG, if running;
1> stop conditional reconfiguration evaluation for CPC or CPA, if configured;
1> if the UE is in (NG) EN-DC:
2> initiate transmission of the SCGFailureInformationNR message.

1> else:
2> initiate transmission of the SCGFailureInformation message.

Furthermore, the method in perspective of the UE described above in FIG. 12 may be performed by first wireless device 100 shown in FIG. 2, the wireless device 100 shown in FIG. 3, the first wireless device 100 shown in FIG. 4 and/or the UE 100 shown in FIG. 5.

More specifically, the UE comprises at least one transceiver, at least processor, and at least one computer memory operably connectable to the at least one processor and storing instructions that, based on being executed by the at least one processor, perform operations.

The operations comprise: entering a deactivated state for a cell group: initiating a transmission of failure information for the cell group while the cell group is in the deactivated state; and suspending a transmission on the cell group based on a cause of initiating the transmission of the failure information for the cell group. The transmission on the cell group may not be suspended based on the cause being a first cause that a beam failure for the cell group is detected while the cell group is in the deactivated state. The transmission on the cell group may be suspended based on the cause being a second cause other than the first cause.

Furthermore, the method in perspective of the UE described above in FIG. 12 may be performed by a software code 105 stored in the memory 104 included in the first wireless device 100 shown in FIG. 4.

More specifically, at least one computer readable medium (CRM) stores instructions that, based on being executed by at least one processor, perform operations comprising: entering a deactivated state for a cell group: initiating a transmission of failure information for the cell group while the cell group is in the deactivated state; and suspending a transmission on the cell group based on a cause of initiating the transmission of the failure information for the cell group. The transmission on the cell group may not be suspended based on the cause being a first cause that a beam failure for the cell group is detected while the cell group is in the deactivated state. The transmission on the cell group may be suspended based on the cause being a second cause other than the first cause.

Furthermore, the method in perspective of the UE described above in FIG. 12 may be performed by control of the processor 102 included in the first wireless device 100 shown in FIG. 2, by control of the communication unit 110 and/or the control unit 120 included in the wireless device 100 shown in FIG. 3, by control of the processor 102 included in the first wireless device 100 shown in FIG. 4 and/or by control of the processor 102 included in the UE 100 shown in FIG. 5.

More specifically, an apparatus configured to/adapted to operate in a wireless communication system (e.g., wireless device/UE) comprises at least processor, and at least one computer memory operably connectable to the at least one processor. The at least one processor is configured to/adapted to perform operations comprising: entering a deactivated state for a cell group: initiating a transmission of failure information for the cell group while the cell group is in the deactivated state; and suspending a transmission on the cell group based on a cause of initiating the transmission of the failure information for the cell group. The transmission on the cell group may not be suspended based on the cause being a first cause that a beam failure for the cell group is detected while the cell group is in the deactivated state. The transmission on the cell group may be suspended based on the cause being a second cause other than the first cause.

Furthermore, the method in perspective of the network node described above in FIG. 13 may be performed by second wireless device 100 shown in FIG. 2, the device 100 shown in FIG. 3, and/or the second wireless device 200 shown in FIG. 4.

More specifically, the network node comprises at least one transceiver, at least processor, and at least one computer memory operably connectable to the at least one processor and storing instructions that, based on being executed by the at least one processor, perform operations.

The operations comprise: transmitting, to a user equipment (UE), a deactivation command to enter a deactivated state for a cell group: receiving, from the UE, failure information for the cell group while the cell group is in the deactivated state; and transmitting, to another network node related to the cell group, the failure information. Whether a transmission on the cell group is suspended may be determined based on a cause of initiating the transmission of the failure information. The transmission on the cell group may not be suspended based on the cause being a first cause that a beam failure for the cell group is detected while the cell group is in the deactivated state. The transmission on the cell group may be suspended based on the cause being a second cause other than the first cause.

In the disclosure, PSCell can be replaced by PCell and SCG can be replaced by MCG.

The present disclosure can have various advantageous effects.

For example, the UE in SCG deactivation state can transmit the SCG failure information to the network even though SCG is suspended to transmission by additionally checking the cause of suspension to transmission on SCG. Therefore, the present disclosure support more time-efficient UE behavior because the UE can more properly indicate to the network that recovery is needed before SCG activation than legacy.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method performed by a user equipment (UE) in a wireless communication system, the method comprising:
entering a deactivated state for a cell group;
initiating a transmission of failure information for the cell group while the cell group is in the deactivated state; and
suspending a transmission on the cell group based on a cause of initiating the transmission of the failure information for the cell group,
wherein the transmission on the cell group is not suspended based on the cause being a first cause that a beam failure for the cell group is detected while the cell group is in the deactivated state, and
wherein the transmission on the cell group is suspended based on the cause being a second cause other than the first cause.

2. The method of claim 1, wherein the cell group comprises a secondary cell group (SCG) including a primary secondary cell (PSCell), and
wherein the beam failure for the cell group comprises a beam failure for the PSCell.

3. The method of claim 1, wherein the second cause comprises at least one of:
a radio link failure (RLF) on the cell group;
an execution failure of a mobility command for the cell group;
a configuration failure of the cell group;
an integrity check failure for the cell group; or
consistent uplink listen-before-talk (LBT) failures on the cell group for operation with an unlicensed band.

4. The method of claim 1, further comprising:
detecting the beam failure for the cell group while the cell group is in the deactivated state,
wherein the initiating of the transmission of the failure information comprises initiating a transmission of first failure information for the cell group upon detecting the beam failure for the cell group while the cell group is in the deactivated state, and
wherein the transmission on the cell group is not suspended based on initiating the transmission of the first failure information upon detecting the beam failure for the cell group while the cell group is in the deactivated state; and
transmitting, to a network, the first failure information based on initiating the transmission of the first failure information.

5. The method of claim 4, wherein the first failure information informs that the beam failure is detected on the cell group.

6. The method of claim 4, further comprising:
after transmitting the first failure information, initiating a transmission of second failure information for the cell group while the transmission on the cell group is not suspended; and
transmitting, to the network, the second failure information based on initiating the transmission of the second failure information.

7. The method of claim 6, wherein the transmission of the second failure information is initiated upon the UE detecting the second cause, and
wherein the second failure information informs that a failure related to the second cause is detected on the cell group.

8. The method of claim 6, wherein the transmission of the second failure information is initiated upon the UE detecting a beam failure for the cell group while the cell group is in the deactivated state, and
wherein the second failure information informs that a beam failure is detected on the cell group.

9. The method of claim 6, further comprising:
receiving, from the network, a signalling for a recovery of the beam failure for the cell group after transmitting the first failure information,
wherein the transmission of the second failure information is initiated before receiving the signalling for a recovery of the beam failure for the cell group.

10. The method of claim 1, wherein the initiating of the transmission of the failure information comprises initiating the transmission of the failure information upon detecting the second cause, further comprising:
transmitting the failure information to a network and suspending the transmission on the cell group based on initiating the transmission of the failure information upon detecting the second cause.

11. The method of claim 10, wherein the suspending of the transmission on the cell group comprises:
suspending the transmission on the cell group, based on the transmission of the failure information being not initiated upon the UE detecting the beam failure for the cell group while the cell group is in the deactivated state.

12. The method of claim 1, wherein the deactivated state comprises a state in which the UE does not monitor a control channel on the cell group or monitors sparser resources for a control channel on the cell group than in an activated state.

13. The method of claim 1, wherein the UE is in communication with at least one of a mobile device, a network, or autonomous vehicles other than the UE.

14. A user equipment (UE) adapted to operate in a wireless communication system, the UE comprising:
at least one transceiver;
at least processor; and
at least one computer memory operably connectable to the at least one processor and storing instructions that, based on being executed by the at least one processor, perform operations comprising:
entering a deactivated state for a cell group;
initiating a transmission of failure information for the cell group while the cell group is in the deactivated state; and
suspending a transmission on the cell group based on a cause of initiating the transmission of the failure information for the cell group,
wherein the transmission on the cell group is not suspended based on the cause being a first cause that a beam failure for the cell group is detected while the cell group is in the deactivated state, and
wherein the transmission on the cell group is suspended based on the cause being a second cause other than the first cause.

15-17. (canceled)

18. A network node adapted to operate in a wireless communication system, the network node comprising:
at least one transceiver;
at least processor; and
at least one computer memory operably connectable to the at least one processor and storing instructions that, based on being executed by the at least one processor, perform operations comprising:
transmitting, to a user equipment (UE), a deactivation command to enter a deactivated state for a cell group;
receiving, from the UE, failure information for the cell group while the cell group is in the deactivated state; and
transmitting, to another network node related to the cell group, the failure information,
wherein whether a transmission on the cell group is suspended is determined based on a cause of initiating the transmission of the failure information,
wherein the transmission on the cell group is not suspended based on the cause being a first cause that a beam failure for the cell group is detected while the cell group is in the deactivated state, and
wherein the transmission on the cell group is suspended based on the cause being a second cause other than the first cause.
